(19) United States
(12) Patent Application Publication
(10) Pub. No.: US 2023/0250915 A1
(43) Pub. Date: Aug. 10, 2023

(54) Insulating Sleeves for Heat Emitters

(71) Applicant: Concept Group LLC, Wellesley, MA (US)

(72) Inventors: Shriram Radhakrishnan, West Palm Beach, FL (US); Peter Roach, Jacksonville, FL (US); Muhammad Khan, Wellesley, MA (US)

(21) Appl. No.: 18/167,215

(22) Filed: Feb. 10, 2023

Related U.S. Application Data
(60) Provisional application No. 63/308,882, filed on Feb. 10, 2022.

(51) Int. Cl. F16L 59/02; F16L 59/065

(52) U.S. Cl. CPC F16L 59/021; F16L 59/065

(57) ABSTRACT

Provided are thermal insulation components, the thermal insulation component extending in the direction of a major axis and the thermal insulation component comprising: an inner wall, the inner wall defining a lumen therein, the lumen having a centerline; an outer wall, the outer wall encircling the inner wall, the outer wall having a plurality of corrugations, the inner wall and the outer wall defining an insulating space therebetween, the insulating space optionally being evacuated; and at least one engagement feature configured to secure the component to an outlet, the engagement feature being arranged such that a line extending radially outward from the centerline of the lumen passes through the engagement feature without passing through the insulating space. Also provided are related methods.

### CROSS-REFERENCE TO RELATED APPLICATIONS

The present application claims priority to and the benefit of U.S. patent application No. 63/308,882, “Insulating Sleeves For Heat Emitters” (filed Feb. 10, 2022). All foregoing applications are incorporated herein by reference in their entireties for any and all purposes.

### TECHNICAL FIELD

The present disclosure relates to the field of vacuum-based thermal insulation.

### BACKGROUND

A number of tools and devices (such as heat guns) operate by directing heat to a target area, e.g., for removing paint, softening adhesives, and for other industrial applications. Such tools, however, can present certain hazards, as the tools can themselves become hot to the touch. Accordingly, there is a long-felt need in the art for thermal insulation components that can be used with heat guns and other similar devices to reduce the hazards presented by hot surfaces of such devices.

### SUMMARY

In meeting the described long-felt needs, the present disclosure provides a thermal insulation component, the thermal insulation component extending in the direction of a major axis and the thermal insulation component comprising: an inner wall, the inner wall defining a lumen therein, the lumen having a centerline; an outer wall, the outer wall encircling the inner wall, the outer wall having a plurality of corrugations, the inner wall and the outer wall defining an insulating space therebetween, the insulating space optionally being evacuated; and at least one engagement feature configured to secure the component to an outlet, the engagement feature being arranged such that a line extending radially outward from the centerline of the lumen passes through the engagement feature without passing through the insulating space.

Also provided are methods, comprising communicating a fluid through the lumen of a component according to the present disclosure, e.g., according to any one of Aspects 1-13.

Further disclosed are methods, comprising affixing a component according to the present disclosure (e.g., according to any one of Aspects 1-13) to a heated fluid dispenser.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1A provides a cutaway view of an example component according to the present disclosure;

FIG. 1B provides a cutaway view of an example component according to the present disclosure;

FIG. 2 provides a cutaway view of an example component according to the present disclosure;

FIG. 3 provides a cutaway view of an example component according to the present disclosure;

FIG. 4 provides a cutaway view of an example component according to the present disclosure; and

FIG. 5 provides a cutaway view of an example component according to the present disclosure.

FIG. 6 provides an example component according to the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

### FIGURES

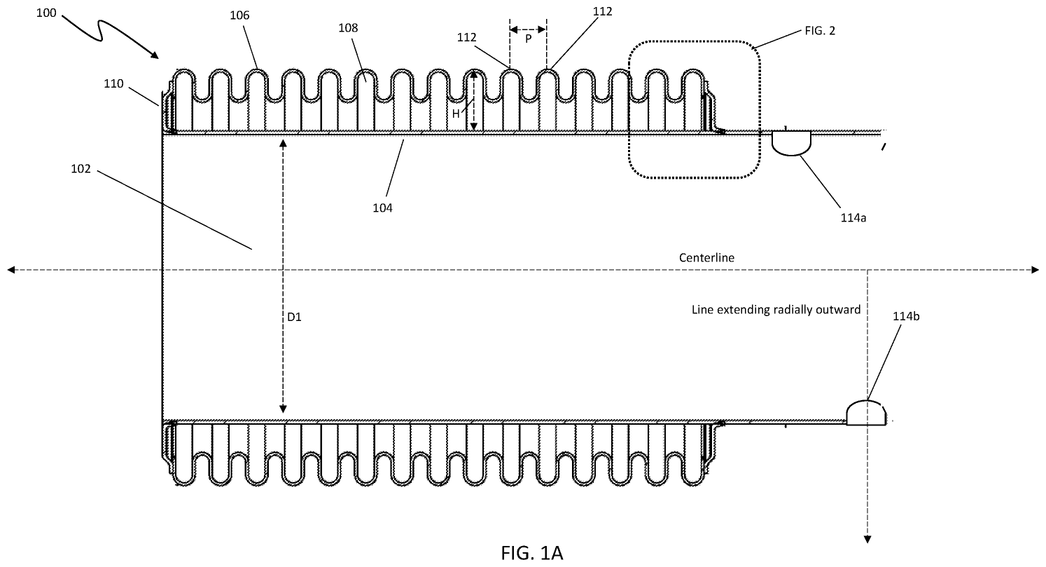

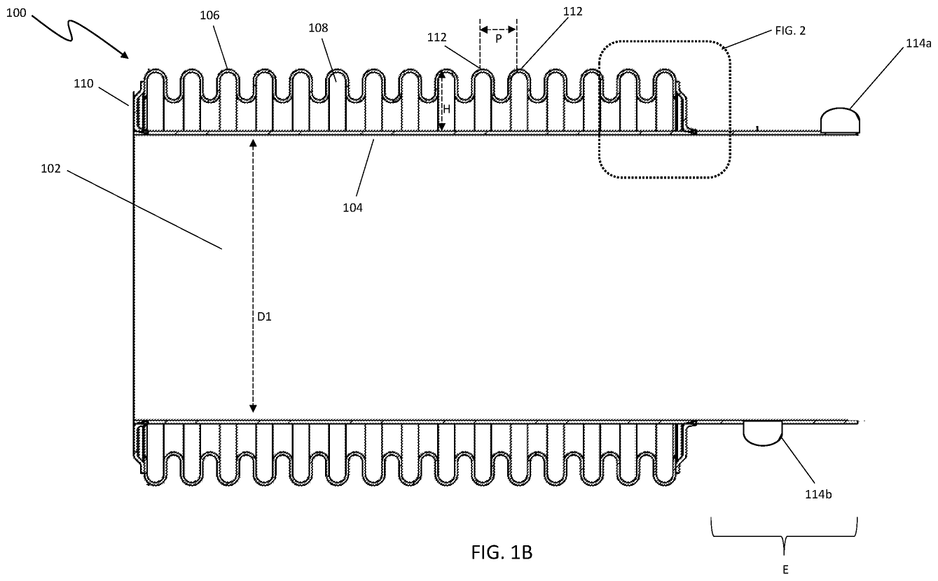

As shown in FIG. 1A, insulating component 100 can include an inner wall 104 and an outer wall 106, with inner wall 104 defining lumen 102 therein. Lumen 102 can have a diameter of D1, which diameter can be selected based on the needs of the user. Diameter D1 can also vary along the length of insulating component 100, e.g., D1 can taper and/or flare along the length of component 100. D1 can also be constant along the length of component 100.

As shown, outer wall 106 can include corrugations 112, which corrugations can also be termed convolutions. Such corrugations can have a period of P, which is defined as the peak-to-peak distance between adjacent corrugations. A corrugation can also define a height H, which can be defined as the distance between inner wall 104 and the peak of the corrugation. The corrugations on a given component 100 can have a constant period, i.e., all corrugations are uniformly spaced. This is not a requirement, however, as the period P between adjacent corrugations can vary such that a component can include a region of corrugations that are closer together and region of corrugations that are further apart from one another. Likewise, a component can include corrugations of different heights, e.g., a region of comparatively short corrugations and a region of comparatively tall corrugations. The corrugations of a given wall can be configured such that if the corrugations were straightened out, the tube would be from about 1.1 to about 4 times the length of the corrugated tube, or from about 1.5 to about 3.5 times the length of the corrugated tube, or from about 2 to about 3 times the length of the corrugated tube.

Without being bound to any particular theory, the corrugations of a component can act as heat sinks and/or to lengthen the path that heat must travel from the lumen to the exterior of the component. (Although not shown in the attached figures, a component can also include a jacket or other shell disposed about outer wall 106, e.g., superposed between at least some of the corrugations of component 100 and the environment exterior to component 100.

Inner wall 104 and outer wall 106 can define a sealed insulating space 108 therebetween. Sealed insulating space 108 can be at a reduced pressure, e.g., from about 10⁻¹ Torr to 10⁻⁸ Torr, from about 10⁻² Torr to about 10⁻⁷ Torr, from about 10⁻³ Torr to about 10⁻⁶ Torr, or even from about 10⁻⁴ Torr to about 10⁻⁵ Torr. Inner wall 104 and outer wall 106 can be formed of the same material (e.g., stainless steel); they can also be formed of different materials that exhibit the same thermal expansion characteristics. This is not a requirement, however, as inner wall 104 and outer wall 106 can be formed of materials that exhibit different thermal expansion characteristics. As an example, inner wall 104 can comprise a material that exhibits greater thermal expansion than outer wall 106. Alternatively, outer wall 106 can comprise a material that exhibits greater thermal expansion than inner wall 104. As an example, one of inner wall 104 and outer wall 106 can be a metal, and the other of inner wall 104 and outer wall 106 can be a ceramic.

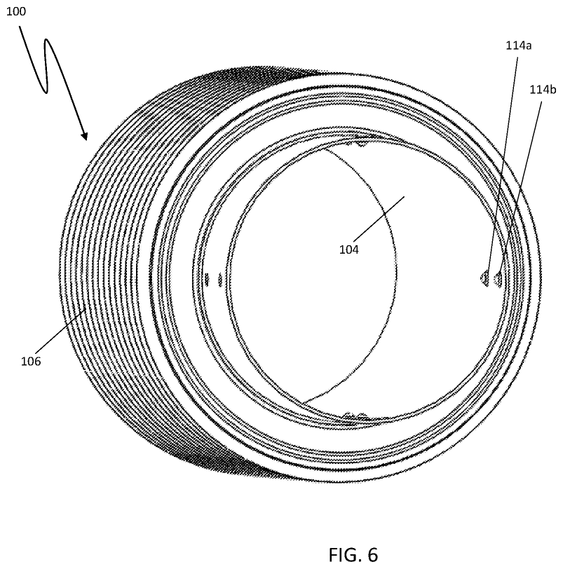

Component 100 can also include engagement features, e.g., dimples 114a and 114b. Such dimples can extend radially toward lumen 102, as shown by non-limiting FIG. 1A and FIG. 6. Dimples can be formed in the material of inner wall 104, e.g., by stamping inner wall 104 so as to form dimples that extend radially toward lumen 102. Alternatively, and as shown in FIG. 1B, dimples 114a and 114b can extend outwardly, i.e., away from lumen 102. In addition to dimples, engagement features can also comprise, for example, grooves, indentations, tabs, slots, threads, tapers, and the like. As shown, an engagement feature can be located at an end of component 100, e.g., at a terminus of inner wall 104. This is not a requirement, however, as an engagement feature can be located inwardly along the length of component 100. As shown in FIG. 1A, an engagement feature can be located on a component at a location that does not overlie a portion of sealed insulating space 108, i.e., such that a line extending radially outwardly from lumen 102 and passes through the engagement feature does not also pass through sealed insulating space 108. This is not a requirement, as component can also be configured such that a line extending radially outwardly from lumen 102 and passes through the engagement feature passes through sealed insulating space 108.

An engagement feature can, in turn, be used to maintain the position of component 100, e.g., via press-fitting component 100 into a heat-supplying device to which component 100 is mated. Alternatively, an engagement feature of component 100 can engage with a complementary feature (e.g., convex dimple engaging with concave dimple) on a heat-supplying device, such as a heat gun, the nozzle of an additive manufacturing device, a welding torch, and the like. This is not a requirement, however, as an engagement feature (e.g., convex dimple) of component 100 can press-fit to a heat-supplying device. In this way, component 100 can be mated to another device that is specifically designed to mate with component 100, but this is a not a requirement, as component 100 can be press-fit to a device that is not necessarily designed to mate specifically with component 100, e.g., to retrofit an existing device to confer improved performance and/or safety on that device. Without being bound to any particular theory or embodiment, the heating of a component (and/or a region to which the component is mated) can modulate the engagement between the component and the region to which the component is mated, e.g., when the heating gives rise to a thermal expansion that in turn effects improved sealing between the component and the region to which the component is mated. Without being bound to any particular theory, a component can gall itself into place on a region to which the component is mated. To the extent there can be an air gap between the component and the device to which the component is mated, such an air gap can, without being bound to any particular theory, give rise to a Venturi effect that pulls outside air in to cool the arrangement.

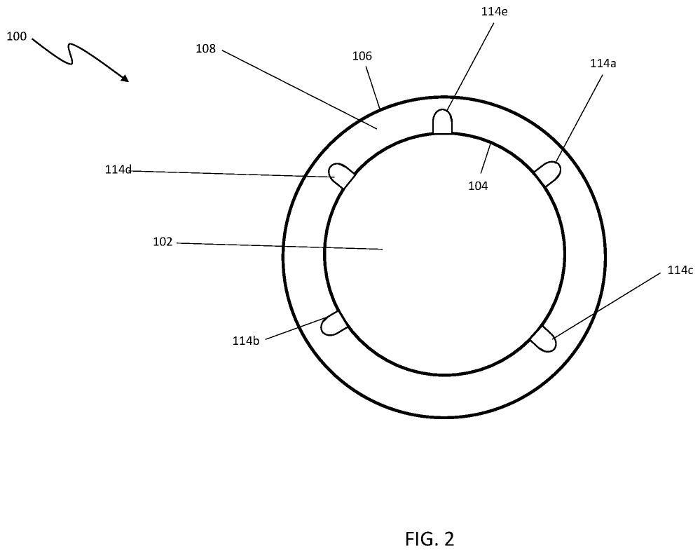

As shown in FIG. 1A, engagement features 114a and 114b do not have to be diametrically opposed to one another, i.e., they do not both need to be located at the same distance from a given end of component 100. As shown in FIG. 2, engagement features (114a, 114b, 114c, 114d, 114e) can be arranged circumferentially around component 100. Engagement features can be arranged regularly around component 100 (e.g., with each engagement feature being separated by the same number of degrees from its adjacent engagement features), but this is not a requirement, as engagement features need not be arranged regularly around component 100. A component can include, e.g., 1 engagement feature, but can also include a plurality of engagement features, e.g., 2, 3, 4, 5, 6, 7, 8, 9, 10, or more engagement features. Components that include 4, 5, 6, 7, or even 8 engagement features (e.g., dimples) are considered particularly suitable. Engagement features can be arranged at 1 distance from an end of component 100, but this is not a requirement, as engagement features can—as shown in FIG. 1A and FIG. 1B—be arranged at different distances from an end of component 100.

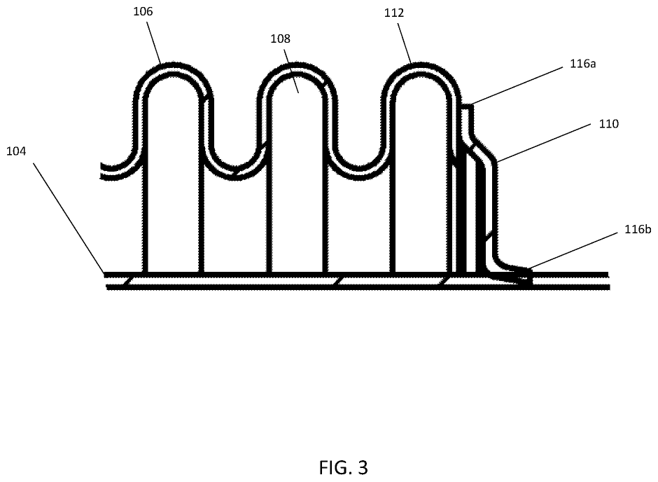

FIG. 3 provides a close-up of the boxed region from FIG. 1A. As shown in FIG. 3, a sealer 110 can be used to seal insulating space 108 located between outer wall 106 and inner wall 104. Sealer 110 can define a first joint 116a between sealer 110 and outer wall 106 and also define a second joint 116b between sealer 110 and inner wall 104. In some embodiments (not shown), outer wall 106 and inner wall 104 can be sealed directly to one another.

Any joint between sealer 110 and outer wall 106 and/or inner wall 106 (as well as any joint between outer wall 106 and inner wall 104) can be a joint according to any one or more of US2018/0106414; US2017/0253416; US2017/0225276; US2017/0120362; US2017/0062774; US2017/0043938; US2016/0084425; US2015/0260332; US2015/0110548; US2014/0090737; US2012/0090817; US2011/0264084; US2008/0121642; US2005/0211711; WO/2019/014463; WO/2019/010385; WO/2018/093781; WO/2018/093773; WO/2018/093776; PCT/US2018/047974; WO/2017/152045; U.S. 62/773,816; and U.S. Pat. No. 6,139,571, the entireties of which documents are incorporated herein for any and all purposes, and which documents provide exemplary walls, sealing processes, and insulating spaces. As explained, such joints can comprise a geometry that provides for removal of a greater number of gas molecules from the space than could otherwise be achieved without the use of a getter material. The elimination of the need for a getter material in the evacuated space to achieve deep vacuums is a benefit of the present invention. By eliminating the need for getter material, the invention provides for deepened vacuums in insulated spaces in which this was not previously possible because of space constraints. Such insulated spaces include those for devices of miniature scale or devices having insulating spaces of extremely narrow width.

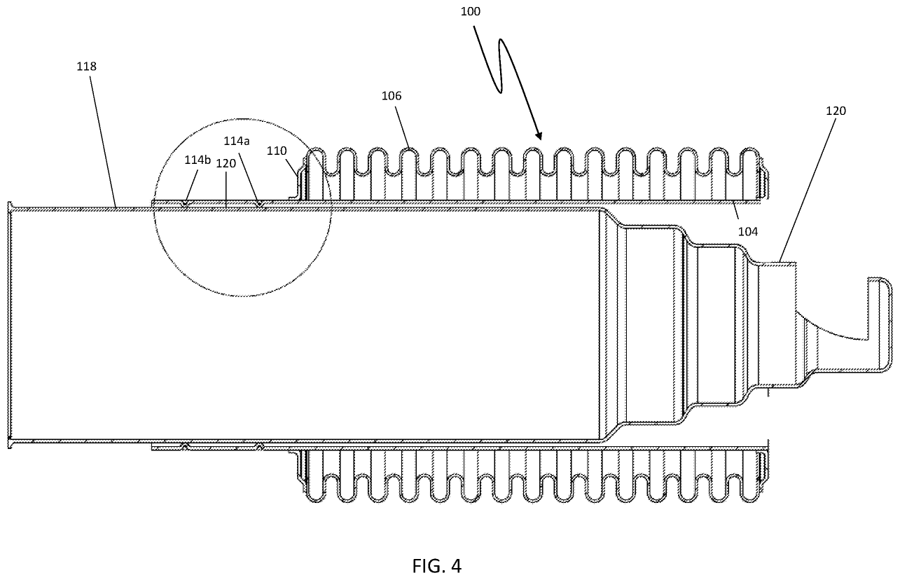

FIG. 4 provides a view of a component 100 according to the present disclosure that is engaged with a nozzle 118. As shown in FIG. 4, engagement features 114a and 114b engage with a wall of nozzle 118, e.g., via press-fitting. Nozzle 118 can include, as shown, a tapered or stepped potion 120. As shown, there can be a space between the inner wall 104 of component 100 and a portion of nozzle 118, e.g., the space between the stepped portion 120 and inner wall 104.

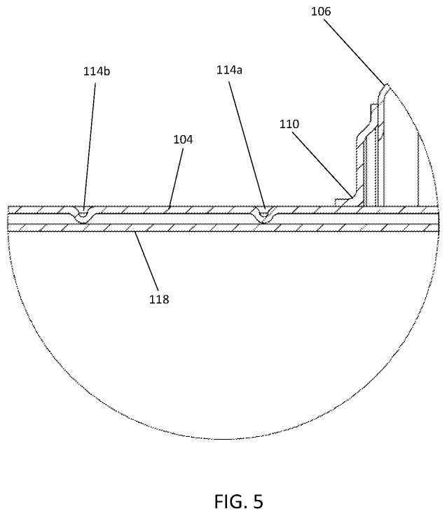

FIG. 5 provides a closer view of the circled region of FIG. 4. As shown, engagement features 114a and 114b (which can be dimples formed in inner wall 104 of component 100) can engage, e.g., via press fitting, with nozzle 118. Although not shown in FIG. 5, nozzle 118 can include one or more features (e.g., dimples) configured to engage with engagement features of component 100. Without being bound to any particular theory or embodiment, the engagement features can be arranged such that component 100 is retained in a certain position on nozzle 118; such engagement features can act as locator features to ensure ease of installation of the component onto the nozzle, as well as reproducible installation of the component onto the nozzle.

Aspects

The following Aspects are illustrative only and do not limit the scope of the present disclosure or the appended claims. Any part or parts of any one or more Aspects can be combined with any part or parts of any one or more other Aspects.

Aspect 1. A thermal insulation component, the thermal insulation component extending in the direction of a major axis and the thermal insulation component comprising: an inner wall, the inner wall defining a lumen therein, the lumen having a centerline; an outer wall, the outer wall encircling the inner wall, the outer wall having a plurality of corrugations, the inner wall and the outer wall defining an insulating space therebetween, the insulating space optionally being evacuated; and at least one engagement feature configured to secure the component to an outlet, the engagement feature being arranged such that a line extending radially outward from the centerline of the lumen passes through the engagement feature without passing through the insulating space.

Aspect 2. The component of claim 1, wherein an engagement feature extends in a direction toward the lumen.

Aspect 3. The component of claim 1, wherein an engagement feature extends in a direction away from the lumen.

Aspect 4. The component of any one of claims 1-3, wherein an engagement feature comprises a dimple.

Aspect 5. The component of claim 4, wherein the dimple is formed in the inner wall.

Aspect 6. The component of any one of claims 1-5, further comprising a sealer sealed to the outer wall and the inner wall, the sealer defining at least a portion of the insulating space.

Aspect 7. The component of claim 6, wherein the sealer and the outer wall define a vent, wherein a distance between the sealer and the outer wall is being variable in a portion of the insulating space adjacent the vent such that gas molecules within the sealed insulating space are directed towards the vent by the variable-distance portion during evacuation of the insulating space, the directing of the gas molecules by the variable-distance portion imparting to the gas molecules a greater probability of egress from the insulating space than ingress thereby providing a deeper vacuum without requiring a getter material within the insulating space.

Aspect 8. The component of claim 6, wherein the sealer and the inner wall define a vent, wherein a distance between the sealer and the inner wall is being variable in a portion of the insulating space adjacent the vent such that gas molecules within the sealed insulating space are directed towards the vent by the variable-distance portion during evacuation of the insulating space, the directing of the gas molecules by the variable-distance portion imparting to the gas molecules a greater probability of egress from the insulating space than ingress thereby providing a deeper vacuum without requiring a getter material within the insulating space.

Aspect 9. The component of any one of claims 1-8, wherein the outer wall and the inner wall exhibit the same thermal expansion characteristics.

Aspect 10. The component of any one of claims 1-8, wherein the outer wall and the inner wall exhibit different thermal expansion characteristics.

Aspect 11. The component of any one of claims 1-10, wherein the insulating space is at a pressure of from about 10⁻¹ Torr to about 10⁻⁹ Torr.

Aspect 12. The component of claim 11, wherein the insulating space is at a pressure of from about 10⁻³ Torr to about 10⁻⁷ Torr.

Aspect 13. The component of claim 12, wherein the insulating space is at a pressure of from about 10⁻⁵ Torr to about 10⁻⁶ Torr.

Aspect 14. A method, comprising communicating a fluid through the lumen of a component according to any one of claims 1-13.

Aspect 15. The method of claim 14, wherein the fluid is heated air.

Aspect 16. The method of any one of claims 14-15, wherein the communicating effects softening of a thermosensitive material.

Aspect 17. A method, comprising affixing a component according to any one of claims 1-13 to a heated fluid dispenser.

Aspect 18. The method of claim 17, wherein the heated fluid dispenser comprises a heat gun.

Aspect 19. The method of any one of claims 17-18, wherein the affixing comprises press-fitting.

Aspect 20. The method of any one of claims 1-19, wherein the affixing is reversible.

What is claimed:

1. A thermal insulation component, the thermal insulation component extending in the direction of a major axis and the thermal insulation component comprising:
an inner wall,
the inner wall defining a lumen therein,
the lumen having a centerline;
an outer wall,
the outer wall encircling the inner wall,
the outer wall having a plurality of corrugations,
the inner wall and the outer wall defining an insulating space therebetween,
the insulating space optionally being evacuated; and
at least one engagement feature configured to secure the component to an outlet,
the engagement feature being arranged such that a line extending radially outward from the centerline of the lumen passes through the engagement feature without passing through the insulating space.

2. The component of claim 1, wherein an engagement feature extends in a direction toward the lumen.

3. The component of claim 1, wherein an engagement feature extends in a direction away from the lumen.

4. The component of claim 1, wherein an engagement feature comprises a dimple.

5. The component of claim 4, wherein the dimple is formed in the inner wall.

6. The component of claim 1, further comprising a sealer sealed to the outer wall and the inner wall, the sealer defining at least a portion of the insulating space.

7. The component of claim 6, wherein the sealer and the outer wall define a vent, wherein a distance between the sealer and the outer wall is being variable in a portion of the insulating space adjacent the vent such that gas molecules within the sealed insulating space are directed towards the vent by the variable-distance portion during evacuation of the insulating space, the directing of the gas molecules by the variable-distance portion imparting to the gas molecules a greater probability of egress from the insulating space than ingress thereby providing a deeper vacuum without requiring a getter material within the insulating space.

8. The component of claim 6, wherein the sealer and the inner wall define a vent, wherein a distance between the sealer and the inner wall is being variable in a portion of the insulating space adjacent the vent such that gas molecules within the sealed insulating space are directed towards the vent by the variable-distance portion during evacuation of the insulating space, the directing of the gas molecules by the variable-distance portion imparting to the gas molecules a greater probability of egress from the insulating space than ingress thereby providing a deeper vacuum without requiring a getter material within the insulating space.

9. The component of claim 1, wherein the outer wall and the inner wall exhibit the same thermal expansion characteristics.

10. The component of claim 1, wherein the outer wall and the inner wall exhibit different thermal expansion characteristics.

11. The component of claim 1, wherein the insulating space is at a pressure of from about 10⁻¹ Torr to about 10⁻⁹ Torr.

12. The component of claim 11, wherein the insulating space is at a pressure of from about 10⁻³ Torr to about 10⁻⁷ Torr.

13. The component of claim 12, wherein the insulating space is at a pressure of from about 10⁻⁵ Torr to about 10⁻⁶ Torr.

14. A method, comprising communicating a fluid through the lumen of a component according to claim 1.

15. The method of claim 14, wherein the fluid is heated air.

16. The method of claim 14, wherein the communicating effects softening of a thermosensitive material.

17. A method, comprising affixing a component according to claim 1 to a heated fluid dispenser.

18. The method of claim 17, wherein the heated fluid dispenser comprises a heat gun.

19. The method of claim 17, wherein the affixing comprises press-fitting.

20. The method of claim 17, wherein the affixing is reversible.
